(19) United States
(12) Patent Application Publication
(10) Pub. No.: US 2005/0178207 A1
(43) Pub. Date: Aug. 18, 2005

(54) Method for recognizing the loading of a particle filter

(76) Inventors: Matthias Stegmaier, Waiblingen-Hohenacker (DE); Juergen Sojka, Gerlingen (DE); Michael Walter, Kornwestheim (DE); Thomas Zein, Stuttgart (DE); Andreas Krautter, Steinheim (DE); Holger Plote, Linz (AT)

Correspondence Address: KENYON & KENYON, ONE BROADWAY, NEW YORK, NY, 10004, US

(21) Appl. No.: 10/514,995

(22) PCT Filed: Jul. 11, 2003
(86) PCT No.: PCT/DE03/02341

(30) Foreign Application Priority Data
Oct. 17, 2002 (DE) 102 48 431.7

(51) Int. Cl. G01L 19/04

(52) U.S. Cl. 73/708

(57) ABSTRACT

A method for determining the loading of a particle filter, in particular in a particle filter for filtering the exhaust gases of an internal combustion engine. A variable characterizing the flow resistance of the particle filter is determined on the basis of the temperature in the particle filter and the pressure in the particle filter, and a conclusion is drawn regarding the loading of the particle filter on the basis of the flow resistance.

### FIELD OF THE INVENTION

The present invention relates to a method for recognizing the loading of a particle filter, in particular of a particle filter for filtering the exhaust gases of an internal combustion engine.

### BACKGROUND INFORMATION

German patent document no. 100 14 224 discusses a method and a device for controlling an internal combustion engine having an exhaust gas aftertreatment system, in which a variable characterizing the state of the exhaust gas aftertreatment system is determined from at least one operating variable of the internal combustion engine.

German patent document no. 101 00 418 discusses a method and a device for controlling an exhaust gas aftertreatment system, a state variable characterizing the state of the exhaust gas aftertreatment system being definable based on at least one pressure differential between the pressure upstream and downstream from the exhaust gas aftertreatment system in first operating states of the internal combustion engine, and a state variable characterizing the exhaust gas aftertreatment system being simulated based on at least one operating variable of the internal combustion engine in second operating states. A variable which is a function of the exhaust gas volume flow, the rotational speed, the injected fuel amount, the supplied fresh air amount, or the driver's intent may be used here as the operating variable.

In this exhaust gas aftertreatment system, the loading state of the particle filter is determined on the basis of the pressure differential. Particularly accurate detection of the loading state is possible in this way. In contrast, in second operating states, the loading state is simulated. These second operating states are characterized in that they do not make accurate detection possible, for example, because the measurement variables are inaccurate in certain operating states, which is the case here in particular if the exhaust gas volume flow assumes small values. By measuring the pressure gradient across the particle filter, conclusions regarding the amount of soot accumulated in the particle filter may be drawn. However, the pressure differential across the filter to be measured depends on the flow states in the filter and in particular on the exhaust gas volume flow, which are not taken into consideration.

### SUMMARY OF THE INVENTION

An object of the exemplary embodiment and/or exemplary method of the present invention is therefore to provide a method for recognizing the loading of a particle filter, which makes it possible to further enhance the accuracy in detecting the loading of the particle filter and also takes into account the exhaust gas volume flow through the particle filter in particular.

The object may be achieved by the features of the exemplary embodiment and/or exemplary method of the present invention described herein. Advantageous embodiments of the exemplary method are described herein.

The exemplary embodiment and/or exemplary method of the present invention uses the flow resistance of the filter as the characteristic variable for the loading, the flow resistance being determined by measuring the pressure drop across the filter and determining the exhaust gas volume flow through the filter. This allows for determining a loading parameter independently of the operating point, i.e., the loading-state of the particle filter is determinable independently of the engine load point.

The temperature in the particle filter may be determined using a model on the basis of the temperature measured by temperature sensors upstream and downstream from the particle filter in the flow direction.

In another exemplary embodiment of the present invention, which only requires one temperature sensor, the temperature may also be determined iteratively using a model on the basis of the temperature measured upstream from the particle filter in the flow direction.

To determine the pressure in the particle filter, the pressure differential across the particle filter is advantageously determined and the pressure in the particle filter is modeled on the basis of this pressure differential taking into account additional variables influencing the pressure.

Furthermore, to determine the pressure in the particle filter, the pressure upstream from the particle filter may be determined, and the pressure in the particle filter may be modeled on the basis of this pressure, taking into account additional variables influencing the pressure.

The advantage of this procedure, namely the use of measured physical parameters for computing the relationships in the filter, in particular the temperature and pressure in the filter, is a substantially higher accuracy of the determination of loading.

### BRIEF DESCRIPTION OF THE DRAWINGS

FIG. 1 shows a particle filter in which the exemplary method according to the present invention is used.

FIG. 2 shows the definition of the flow resistance of the particle filter illustrated in FIG. 1.

### DETAILED DESCRIPTION

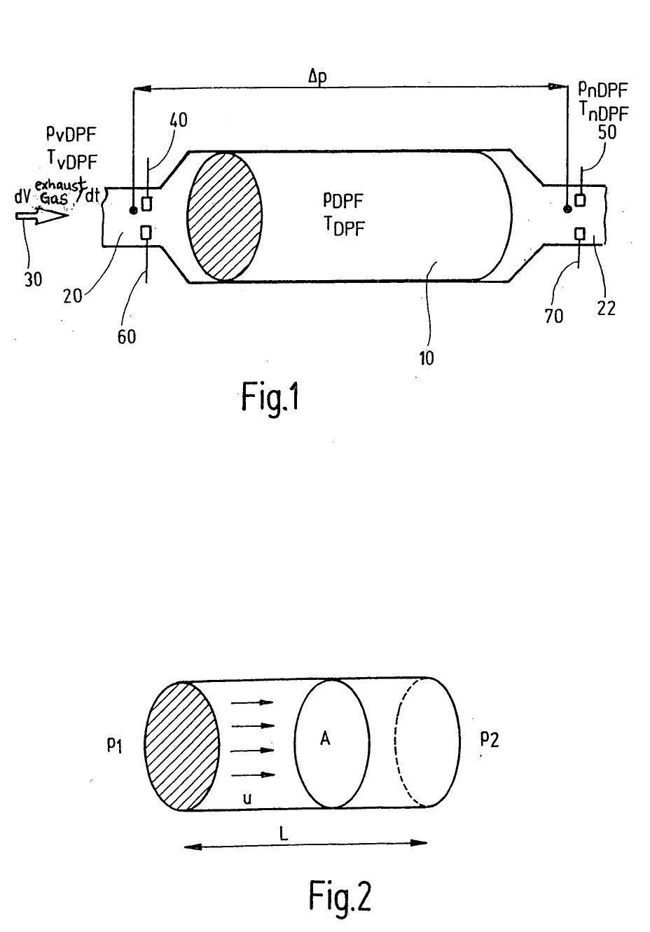

A particle filter 10, illustrated in FIG. 1, receives exhaust gases (schematically illustrated by an arrow 30) via an exhaust pipe 20. The exhaust gases filtered in filter 10 are discharged into the environment via a pipe 22. Filter 10 may be situated in an exhaust gas aftertreatment system, for example, as illustrated in German patent document no. 100 14 224, in particular col. 1, line 67 through col. 3, to which reference is made in this respect, and whose contents are hereby included in this Application.

The flow conditions in particle filter 10 are schematically illustrated in FIG. 2. The pressure drop in a flowed-through filter may be approximated using Darcy's law. Filter 10 is considered as porous medium here. Assuming steady-state flow and neglecting inlet and outlet losses and the quadratic corrections in Darcy's law, the following pressure gradient results:
−dp/dx=(v/K)·u
where v is the viscosity of the gas; K is the permeability of filter 10, and u is the velocity of the flowing gas. Flow resistance resflow_{DPF} of particle filter 10 may be assumed to be the quotient of the pressure differential across filter 10 and the exhaust gas volume flow through filter 10:
resflow_{DPF}=(p_{vDPF}−P_{nDPF})/(dVₑₓₕ/dt)=Δp_{DPF}/(dVₑₓₕ/dt)
where p_{vDPF} is the pressure upstream from the filter; P_{nDPF} is the pressure downstream from the filter; and dVₑₓₕ/dt is the volume flow of the exhaust gas. This exhaust gas volume flow may be determined using the following equation, where mass air flow dmₐᵢᵣ/dt· may be determinable using a mass air flow meter, and the mass flow of the fuel, for example, the mass flow of diesel fuel dm_{diesel}/dt may be determined in a control device:
dVₑₓₕ/dt=((dmₐᵢᵣ/dt)+(dm_{diesel}/dt))·R·T/p

From the above equations and the relationship
U·A=dVₑₓₕ/dt
the following relationship results for the flow resistance, taking into consideration that viscosity v of the gas is also a function of temperature:
resflow_{DPF}=Δp_{DPF}/(dVₑₓₕ/dt)=(L·v(T))/(A·K),
where L is the length of filter 10, and A is its cross-section area, which are not variable and therefore represent parameters of filter 10. The above relationship is valid as long as filter 10 is not loaded with soot. Loading of filter 10 with soot modifies permeability K and thus flow resistance resflow_{DPF}. Using a loading-dependent permeability K*, the following relationship results for the flow resistance:
resflow*_{DPF}=(Δp_{DPF}*/(dVₑₓₕ/dt))·(v(Tₒ)/v(T))=(L/A)·(v(Tₒ)/K*)=const/K*

In other words, permeability and thus the flow resistance of particle filter 10 change as a function of loading; temperature T and pressure p in filter 10 must be known for determining the flow resistance. Different procedures are provided for determining this.

For example, to determine the temperature in filter 10, a temperature sensor 40 may be placed upstream from filter 10 and a temperature sensor 50 downstream from filter 10 in the exhaust gas flow direction. By determining temperatures T_{vDPF} upstream and T_{nDPF} downstream from filter 10, a mean gas temperature T_{gas—mean} may be determined by averaging these two temperatures.
T_{gas—mean}=0.5(T_{vDPF}+T_{nDPF})

In addition, assuming that, when the exhaust gas flows through the filter material, the exhaust gas temperature is equal to that of filter 10, a heat balance in filter 10 may result in an improved model, this modeling being performed according to the following formula:
T_{DPF}=(1/C_{DPF})·∫(dmₑₓₕ/dt)·Cₚₑₓₕ·(T_{nDPF}−T_{vDPF})·dt
where C_{DPF} is the specific heat capacity of the filter and Cₚₑₓₕ is the heat capacity of exhaust gas mass flow dmₑₓₕ/dt.

In another exemplary embodiment, only temperature sensor 40 is used upstream from filter 10. In this case, the temperature downstream from filter 10 is determined iteratively on the basis of the above equation according to the following iteration:
T_{nDPF}=(T_{DPF}·β)+(T_{nDPF}·(1−β)

In this case, in a first calculation in a control unit (not shown), particle filter temperature T_{DPF} is defined by an initialization value. Starting from a second iteration step, temperature T_{DPF} is determined from the previous iteration step. This is possible because the temperature of filter 10 changes on a substantially greater time scale than the calculation time of the model. Variable β shows which portion of the exhaust gas stream is involved in heat exchange with filter 10. Its complement (1−-β) is therefore the portion of the exhaust gas stream which may pass through filter 10 without heat exchange.

Pressure p_{DPF} in the filter is determined as follows: Normally there is a pressure sensor 60 upstream from filter 10 in the flow direction and a pressure sensor 70 downstream from filter 10 in the flow direction or a differential pressure sensor over filter 10, which determine a differential pressure across filter 10, which provides the pressure drop across filter 10. A single pressure sensor 60 may also be provided upstream from filter 10 in the flow direction to determine the pressure in filter 10.

Pressure p_{DPF} in filter 10 is determined from atmospheric pressure pₐₜₘ and the pressure drop of a muffler situated in exhaust gas pipe 22 (not illustrated) Δp_{muffler}, as well as the pressure drop due to the filter Δp_{DPF} according to the following equation:
p_{DPF}=pₐₜₘ+Δp_{muffler}+0.5*Δp_{DPF}

If only absolute pressure sensor 60 is provided upstream from particle filter 10, the following equation applies:
p_{DPF}=0.5*(pₐₜₘ+Δp_{muffler}+p_{vPF})

The main advantage of the above-described method is that the loading state may be provided independently of the engine load point when filter 10 is used in the exhaust gas aftertreatment system of an internal combustion engine. Converting the measured physical parameters to variables which represent the conditions in filter 10 allows the loading state to be determined with considerably higher accuracy.

1-5. (canceled)

6. A method for determining a loading of a particle filter, the method comprising:
determining a variable characterizing a flow resistance of the particle filter based on a temperature in the particle filter and a pressure difference across the particle filter; and
determining a conclusion regarding the loading of the particle filter based on the flow resistance;
wherein a pressure upstream from the particle filter is measured, and the pressure difference across the particle filter is modeled based on the pressure.

7. The method of claim 6, wherein the temperature in the particle filter is determined using a model based on a temperature measured in a flow direction upstream and downstream from the particle filter by temperature sensors.

8. The method of claim 6, wherein the temperature in the particle filter is determined iteratively using a model based on a temperature measured in a flow direction upstream from the particle filter by at least one temperature sensor.

9. The method of claim 6, wherein to determine the pressure in the particle filter, the pressure differential across the particle filter is determined, and the pressure in the particle filter is modeled based on the pressure differential.

10. The method of claim 6, wherein to determine the pressure in the particle filter, the pressure upstream from the particle filter is determined, and the pressure in the particle filter is modeled based on the pressure.

11. The method of claim 6, wherein the particle filter is for filtering an exhaust gas of an internal combustion engine.

12. The method of claim 7, wherein to determine the pressure in the particle filter, the pressure differential across the particle filter is determined, and the pressure in the particle filter is modeled based on the pressure differential.

13. The method of claim 7, wherein to determine the pressure in the particle filter, the pressure upstream from the particle filter is determined, and the pressure in the particle filter is modeled based on the pressure.

14. The method of claim 8, wherein to determine the pressure in the particle filter, the pressure differential across the particle filter is determined, and the pressure in the particle filter is modeled based on the pressure differential.

15. The method of claim 8, wherein to determine the pressure in the particle filter, the pressure upstream from the particle filter is determined, and the pressure in the particle filter is modeled based on the pressure.
